(19) United States
(12) Patent Application Publication
(10) Pub. No.: US 2008/0250190 A1
(43) Pub. Date: Oct. 9, 2008

(54) PORTABLE MEMORY DEVICE OPERATING SYSTEM AND METHOD OF USING SAME

(76) Inventor: BRIAN JOHNSON, Auburn, WA (US)

Correspondence Address: THE SONI LAW FIRM, 55 S. LAKE AVE SUITE 720, PASADENA, CA, 91101, US

(21) Appl. No.: 11/695,604

(22) Filed: Apr. 3, 2007

(51) Int. Cl. G06F 12/00; G06F 3/00

(52) U.S. Cl. 711/103; 715/748

(57) ABSTRACT

A portable operating system for use by a user on a portable memory device, the system being accessible by the user on a primary host computer having a host graphical user interface. The system includes a portable graphical user interface accessible by the user when the portable memory device is placed into communication with the primary host computer, at least one portable application executable by the user via the portable graphical user interface, and a file system accessible by the user. Dragging at least one file from a host graphical user interface of the primary host computer to the portable graphical user interface activates a file system to transfer files into respective portable file folders corresponding to the respective filetype.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates to field of portable memory devices, and more specifically operating systems for the same.

USB flash memories are becoming increasingly popular nowadays, sold in astronomical quantities every year, owing to the ever increasing capacity to store data, comparatively low production cost, remarkable stability against external physical disturbance, and most of all, compactness and portability. For the various advantages, they are most convenient as a medium not only for storing data, but for transferring data or files between different computers. Indeed, the flash memory drives are practically replacing all other types of conventional memory and are used in a wide range of electrical devices that need memory and have standardized USB interfaces, such as PDAs, cellular or smart phones, MP3 players, digital cameras, and so on.

As the storage capacity of flash memories increases rapidly, there is increasing demand and need for the flash memories to perform more diverse functions beyond the simple function of storing personal data, media files, or documents. In particular, such a need arises when the flash drive or a flash memory-employing handheld device is connected to a host computer via a USB port, cable, or other known wireless technologies to transfer files therebetween, or otherwise handle (delete, rename, change file attributes and etc.) or run an application on the files stored in the flesh memory. For that, a couple of different types of media file management software have been developed for the flash drive or a flash memory-employing handheld device. Such management programs are launched either manually by a user's selection after connection of the flash drive or flash memory-employing handheld device to a host computer or automatically upon the connection, and typically provide a graphic user interface (GUI) on a screen of the host computer for accepting user's command.

In many cases, a user may need to transfer multiple files in various different format, such as movie files, audio files, still digital images, spreadsheet files, or document files, from a host computer to a flash drive or a flash memory-employing handheld device, or vice versa. Advantageously, such transferred files of different types are stored in different logical sections (folders or directories) in a destination memory for better viewing, managing, or handling of the files. Such transfer of multiple files into multiple folders in a destination medium requires, with a typical file manager in the prior art, multiple interventions or commands to be made by a user on a GUI provided by the file manager. For example, the user must first select files of a first type in a host computer, and next browse and select a folder in a destination medium, and finally give a “copy” or “move” command to effect the transfer of the selected files. For files of a second type, the user must tediously repeat all the same procedures, and so on. Sometimes, if the folders in the destination medium do not exist, the user also must create them and assign a name to the respective folders either before or during the file transfer. This is very inconvenient and time consuming. Therefore, it is desirable to provide a management software for a flash drive or a flash memory-employing handheld device by which, multiple files of different formats selected from a host computer are automatically sorted or classified and separately transferred into a set of predetermined folders in a storage medium of the flash drive or a flash memory-employing handheld device, and further, such automatic sorting and transferring of multiple files into separate folders is effected by minimum user interventions, most desirably, by a single action of a user.

It would be yet desirable if such file management program is stored in the flash drive or flash memory-employing handheld device, rather than in the storage device of the host computer so as to be conveniently used on different host computers, and further, is automatically launched upon connection to the host computer without necessitating a user's action to launch it.

Also, usually, in order to access and open a file of a given format stored in the flash drive a particular application is needed, but in many cases, such application may not exist in the host computer, or even if it does, its version may not be compatible with the specifics of the file so as to open the file. Therefore, it is also desirable to provide a flash drive or a flash memory-employing handheld device that carries applications specific to the files therein so that the files may be accessed and worked on even on a host computer on which those applications are not installed. It would be still desirable if the file management program in the flash drive or flash memory-employing handheld device is configured, as in a WINDOW environment of most PC, to pre-associate a specific file format with a specific corresponding application so that each file stored therein can be open by the corresponding application simply by, for example, clicking on the name of the file on the GUI.

Some prior art references teach different types of file management software operable on a flash drive or a handheld computing device having a flash or non-volatile memory. But none of the software addresses the problem or need described above. For instance, US Pat. Publication No. 2005/0027712 discloses a method by which a collection of files is automatically sorted, based on context-related meta data of each file such as, time of creation, interval bet successive creations, or location of creation of files, and stored into clusters newly-created and assigned a new name during the process, which are displayed on a GUI to allow a user to change the location of files to another cluster, the name of the cluster, and further, initiate applications to selected files on the GUI. The generated cluster structure and the files contained therein may be stored locally in a host computer or in a remote storage via a network, or in a portable memory device such as a flash drive. The reference, however, fails to disclose any method by which the automatic sorting and downloading of sorted files and clusters into a portable memory device by a single action of a user. Rather, the disclosed method appears to require a separate user's action of downloading the generated clusters and files into the portable memory device subsequent to the sorting and their generation which requires another user's action. Also, the reference fails to disclose automatic sorting of files according to file format and storing sorted files a pre-defined folders in the memory of an external portable device. Further, the file manager in the reference implementing such method is not stored in a portable memory device so as to be conveniently carried with the portable device, but in a host computer or a remote server connected to the host server.

A couple of other references, such as US Pat. Publication No. 2005/0160079 and US Pat. Publication No. 2004/0249844 disclose a method of automatically organizing and sorting assorted files of diverse formats into different groups. But in those references such sorting is performed only for the purpose of providing organized display of the files stored on a computing device so that a user can better handle them on the same device. Similarly, US 2005/160107 teaches efficiently categorizing internet search results according to keywords to best present the results to a user. These references fail to teach sorting of assorted files by file types in a storage medium of a host computer and separate storing of them into pre-defined folders in an external portable storage medium, much less a single user's action to effectuate such process.

US Pat. Publication No. 2004/0095382 discloses a method, implemented by a data management program in a portable memory device, of storing a user's personalized computing preferences, such as settings, OS, applications, file structures, or user's data, in the portable memory device and transporting them to multiple host computers to reproduce the same computing environment on them. Although the references teaches carrying application software and associated files in a portable device and running the application on a host computer that does not have the application, it appears to fail to teach any association between the application and files stored in the portable device that enables launching of the application and opening a particular file on a host computer by a user's single action such as ‘clicking’ on the file name within the GUI provided by the management program. Also, the reference fails to disclose any automatic sorting of files according to file formats and storing them into separate folders pre-defined in the portable memory device, much less the capability of accomplishing such process by a single user's action.

### SUMMARY OF THE INVENTION

In accordance with a preferred embodiment of the present invention, there is provided a portable operating system for use by a user on a portable memory device. The system is accessible by the user on a primary host computer having a host graphical interface. The system includes a portable graphical interface accessible by the user when the portable memory device is placed into communication with the primary host computer. The system also includes at least one portable application executable by the user via the portable graphical user interface. The system also includes a file system accessible by the user via the portable graphical user interface for bidirectional transfer of files between the portable memory device and the primary host computer. The file system defines at least one portable file folder on the portable memory device for storing at least one file therein. Each of the at least one portable file folders correspond to a respective filetype. Dragging at least one file from the host graphical user interface of the primary host computer to the portable graphical user interface activates the file system to transfer each of the at least one files into a respective one of at least one portable file folders corresponding to the respective filetype.

At least one file is preferably associated with a respective one of the at least one portable application such that execution of the at least one portable file launches the at least one portable application associated therewith. Execution of the at least one portable application may be performed independently of default file associations defined by the primary host computer.

The portable graphical user interface may be configured to be compatible with a second host computer having a different operating system than the primary host computer. The portable graphical user interface may be automatically launched without user interaction when the portable memory device is connected to one of the primary and secondary host computers.

The portable application may be a music player while the at least one portable file folder includes a music file folder. The filetype corresponding to the music file folder is a music file.

The at least one portable file folder may be a music file folder, a photo file folder, a document file folder, or a video file folder while the portable application may be a music player, a photo viewer, a document editor, and a video player respectively.

The portable graphical user interface may be configured to connect to master server via the Internet and store identification corresponding to the portable memory device thereon.

The portable graphical user interface may be programmed using Adobe® Flash® software and the file system may be programmed used C++ programming language. The portable graphical user interface and the file system may be compiled together used MDM Zinc™ software.

There is also provided a method of allowing a user to transfer at least one file from a primary host file folder in a primary host computer to a portable memory device, and providing the user with access to the at least one file. The method includes storing a portable operating system on the portable memory device, the portable operating system having a portable graphical user interface. At least one portable file folder is created on the portable memory device, each of the at least one portable file folders corresponding to a respective filetype. The portable operating system is loaded on to the primary host computer from the portable memory device. The portable graphical user interface is displayed on the primary host computer. If the at least one file from the primary host file folder is dragged to the portable graphical user interface by the user, then the at least one file is sorted by filetype. Each of the at least one files is transferred from the primary host file folder to a respective one of the at least one portable file folders on the portable memory device.

Optionally, the at least one file may be associated with a respective one of the at least one portable application. This may be performed independently of default file associations defined by the primary host computer. The at least one portable application may also be launched and associated with the at least one file and opened for access by the user. Such association may be performed without user interaction when the portable memory device is connected to one of the primary and secondary host computers.

### BRIEF DESCRIPTION OF THE DRAWINGS

FIG. 1 illustrates a system-level diagram of the invention when one or both of the primary and secondary host computers connect to a master server through the Internet;

FIG. 2 illustrates a system-level diagram of the invention showing the novel file sorting features from a host graphical interface to a portable graphical user interface;

FIG. 3 illustrates a window of the file system;

FIG. 4 illustrates a screen from the portable graphical user interface for selecting portable applications therewith;

FIG. 6 illustrates a screen from the portable graphical user interface for searching for files on the portable memory device;

FIG. 7 illustrates an account management screen from the portable graphical user interface;

FIG. 8 illustrates a photo sharing application from the portable graphical user interface;

FIG. 9 illustrates a portable application, a music player, from the portable graphical user interface; and

FIG. 10 illustrates a flow chart of the method of allowing a user to transfer files from the primary host file folder to a portable member device.

### DETAILED DESCRIPTION OF THE PREFERRED EMBODIMENT

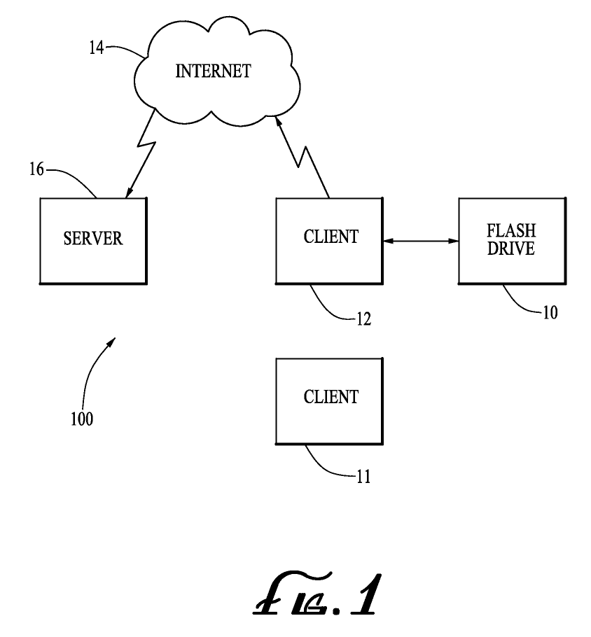

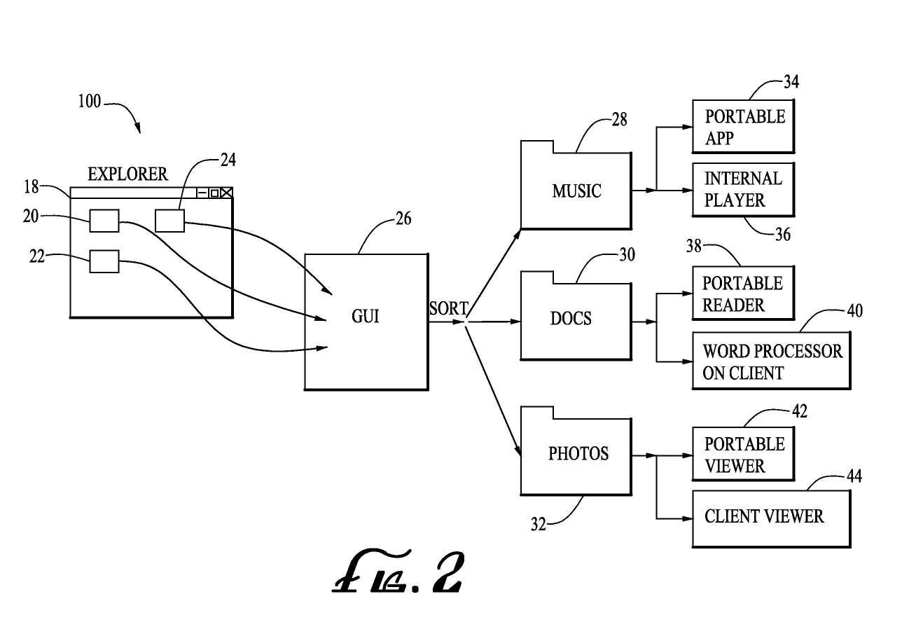

Referring now to the drawings wherein the showings are for purposes of illustrating preferred embodiments of the present invention only, and not for purposes of limiting the same, in FIGS. 1-2, a preferred embodiment of the portable operating system 100 for use on a portable memory device 10 on a primary host computer 12 having a host graphical user interface (not shown), such as Microsoft® Windows® XP or Mac® OS X. The primary host computer 12 is preferably a PC or a Mac, but may also include other types of systems that support USB flash drives. The portable graphical user interface 26 is preferably accessible by the user when the portable memory device 10 is placed into communication with the primary host computer 12. Even more preferably, the portable graphical user interface 26 appears on the primary host computer 11 screen automatically. By placing files on the portable memory device 10 that make it appear to be a CD-ROM, operating systems such as Windows XP will give the user the option to automatically run the system 100. In doing so, the portable operating system 12 is truly portable in that a user may familiarize himself or herself with the interface 26 and quickly be able to access his or her files without having to rely upon knowledge of the operating system existing on the primary host computer 12 or the secondary host computer 11.

At least one portable application 34, 38, and 42 may be executed by the user via the portable graphical user interface 26. Or, an internal application 36, 40, or 44 may be similarly executed by the user. Optionally, both internal applications 36, 40, and 44 and portable applications 34, 38, and 42 may be provided in the system 100 and configured by the user so as to allow the user to set their own file associations within the system 100.

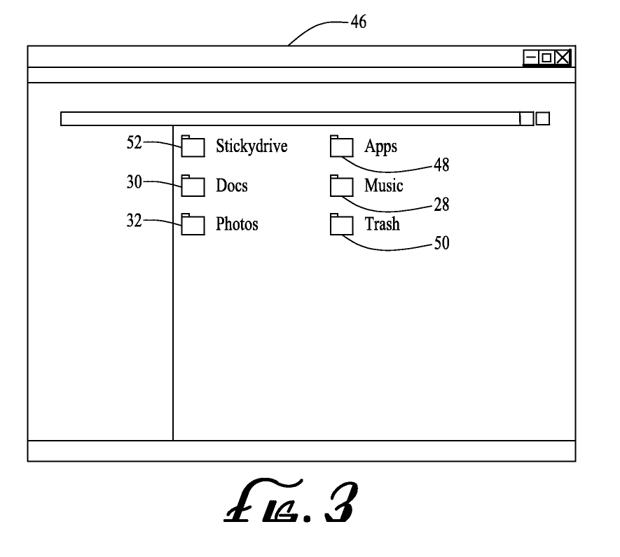

As shown in FIG. 3, a file system 46 may be provided which is accessible by the user via the portable graphical user interface 26 for bidirectional transfer of files between the portable memory device 10 and the primary host computer 12. The file system defines at least one portable file folder 28, 30, 32 on the portable memory device 10 for storing at least one file therein. Each of the at least one portable file folders 28, 30, and 32 correspond to a respective filetype. Each of the file folders 28, 30 and 32 may include a series of similar files with similar file extensions. For example, the “Docs” folder 30 may include documents bearing the extension .DOC, .WPD, TXT, etc. Thus, each folder 28, 30, and 32 is dedicated to the specific type of file based upon filetype. Preferably, such sorting and classification is done without prompting the user and without the user having to decide what type of file it is. In this respect, the user has very little to learn of the system 100. Also included in this file system is a self-contained trash folder 50 such that files deleted from the system 100 via the portable graphical user interface 26 are temporarily stored in this folder 50 instead of on the primary host computer 12 folder. Thus, if a user accidentally deletes a file while using the system 100 on a secondary host computer 11 and later does not recognize that the file was accidentally deleted until returning home and accessing the system 100 on the primary host computer 10, the file may be easily retrieved from the trash folder 50. This is currently not the case with traditional flash storage software and flash drives that are treated as merely additional drives on an operating system. The native operating system on a host computer would ordinarily manage and handle deleted files.

As shown in FIG. 2, advantageously, dragging at least one file from the host graphical user interface 18 (shown as “Explorer”) of the primary host computer 12 to the portable graphical user interface 26 triggers the file system to transfer each of the at least one file into a respective one of the at least one portable file folder corresponding to the respective filetype. The files 20, 22, and 24 may each be of a different filetype. Yet, if a user drags all of the files 20, 22, and 24 together to the portable graphical user interface 26, the system 100 silently and without user interaction may sort the files by filetype into the corresponding directories 28, 30, and 32. More specifically, at least one of the files 20, 22, and 24 may be associated with a respective one of the at least one portable application 34, 38, 42 such that execution of the at least one portable file launches the at least one portable application 34, 38, and 42 associated therewith. For example, after transferring the files to the device 10, as shown in FIG. 5, a user may enter a search string 200 in a search box 202. Thereafter, the file system can return a list of results 204 that alphanumerically match the search string, irrespective of file extension. The user may then double-click on one of the results 204 to have an appropriate application 34, 38, or 42 launch within the device 10 irrespective of the applications existing on the primary host computer 12. This is extremely useful when the primary or secondary host computers 12 and 11 do not have an appropriate application for the filetype.

Advantageously, this sorting and automatic launching of the application may be performed independently of the default file associations defined by the primary host computer 12. Normally, Windows XP contains a database of file associations stored in the registry which tell the operating system which applications are to be launched if and when a user double-clicks on a particular data file. Normally, double-clicking on a datafile on a flash drive will simply launch the application that Windows associates with that file. However, according to the present invention, the system 100 circumvents the file associations set forth by Windows and applies it's own to ensure that the user is provided with the same consistent applications each time the data files are accessed, across PC and Mac platforms and irrespective of the installed applications on the host computer.

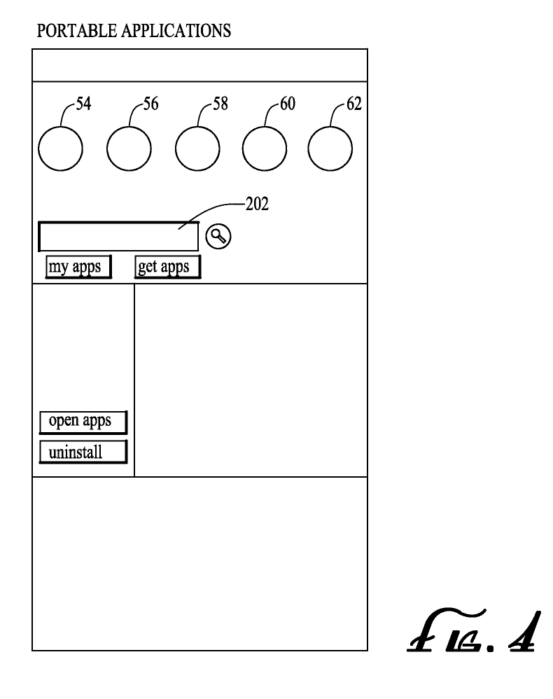

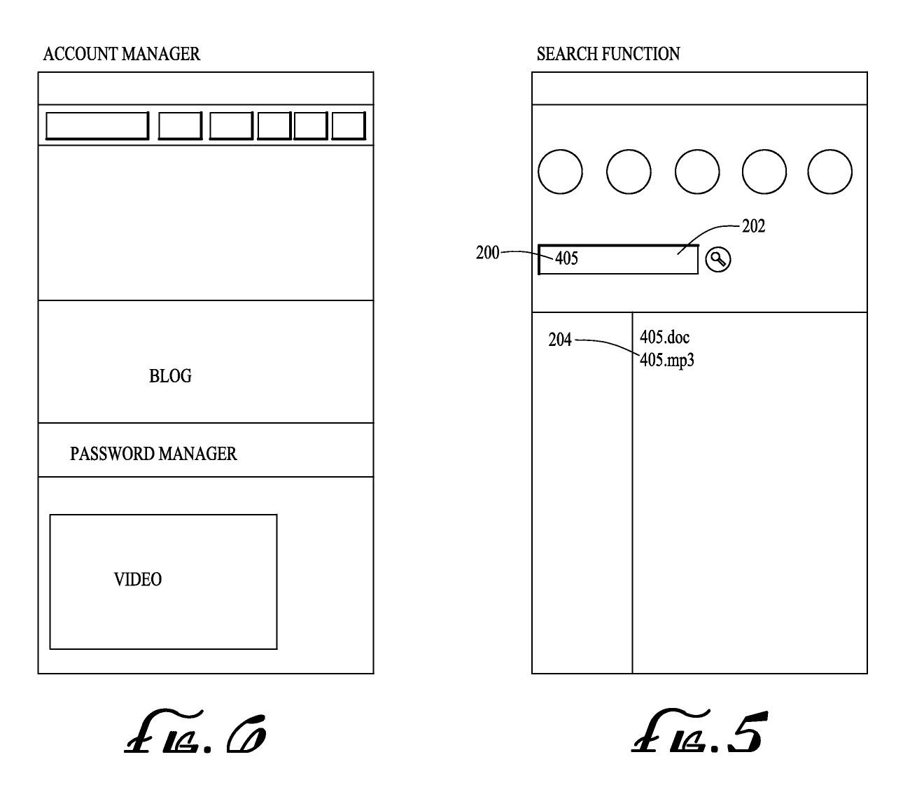

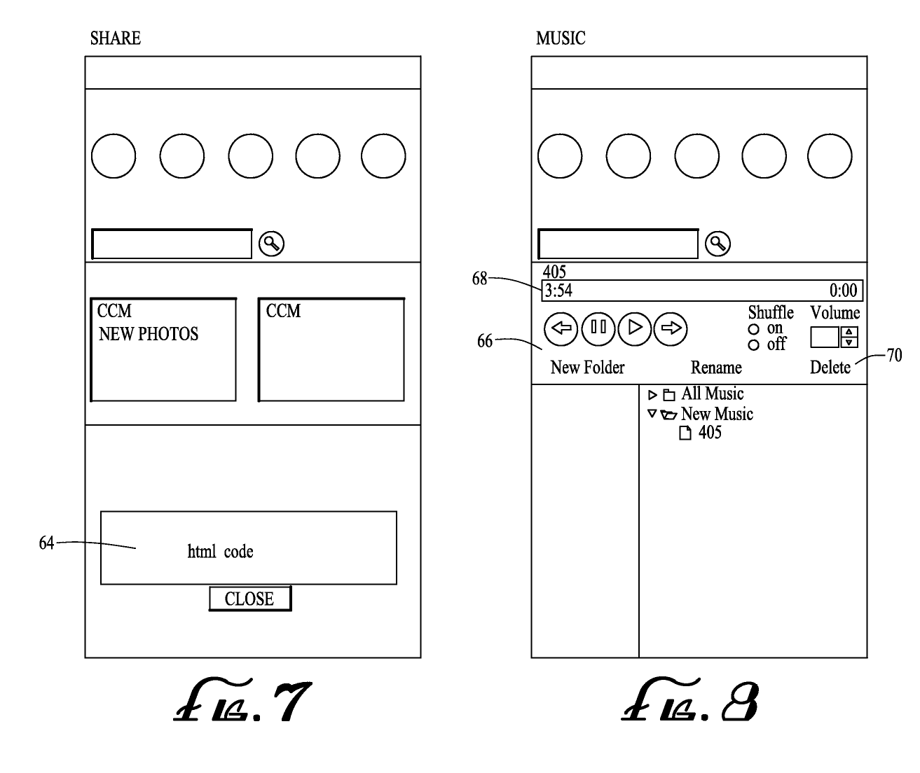

As shown in FIG. 4, a typical representation of the portable graphical user interface 26 is provided. Any one of the buttons 54, 56, 58, 60, and 62 may be used as application buttons for accessing separate menus corresponding to a type of application. For example, as shown in FIG. 7, an application for the sharing of photos online may be launched via one of the buttons 54, 56, 58, 60 and 62 which are preferably constantly displayed, even when switching applications. In such a photo sharing application, photos from the user's device 10 may be uploaded to a server, or the master server 16, such that html code is returned to the user for posting a link to the photo or embedding the photo on a website or social networking site such as www.myspace.com. As shown in FIG. 8, a typical screen showing the music application is illustrated with transport controls and a song progress indicator bar 68. Individual songs may be deleted via the delete button 70, which then sends the file to the trash folder 50 on the portable memory device 10.

The portable memory device 10, when connected to a primary host computer 12 executes code within the portable operating system to detect the presence of a connection to the Internet 14. For example, executing a simple command to be transmitted over the Internet such as “ping www.website.com” may be sent to determine whether a connection to the Internet 14 exists. If the command is successful, a connection does exist, and the portable operating system may connect to a master server 16. The portable operating system may be configured to assign a unique identifier to itself and the portable memory device it resides upon. If an Internet connection is detected, the portable operating system may then transmit the unique identifier to the master server 16.

Advantageously, such connection allows for the operator of the master server 16 to track the first time a customer inserts the portable memory device 10 into the primary host computer 12. The data relating to only the insertion of the portable memory device upon the primary host computer or any other computer is valuable for the inferential data it provides. For example, it can be determined how many times a user connects the portable memory device 10 to any computer, which would indicate how useful the user finds the software. The timing of the connection can also be important to determine what times of the day the user prefers to use the primary host computer 12. Use of a traceroute command or other software to track the source of the user's IP address may also be useful to determine what city, state, or country the user primarily resides within. While such tracking may be done without requiring the user's interaction, it is still distinguishable from spyware software in that no personally identifiable data is collected. Yet, the system may be configured for such personally identifiable tracking if necessary, where perhaps the user wishes to voluntarily submit such information. In this respect, while many websites can track the frequency that a user visits the site by installing cookies on the user's computer, the use of a unique identifier in the portable operating systems allows for more sophisticated tracking that is not dependant upon the specific computer, operating system, or web browser.

Even more advantageously, due to the fact that each copy of the portable operating system is assigned a unique identifier and each is then tracked through the master server 16, the possibilities of interacting with the user of the portable operating system and/or configuring the software available to the user is limitless. For example, remote updates to the system 100 may be effectuated such that the system 100 is always running the most current version. Forms, documents, pictures, videos and other files supported by the system 100 which are shared across several individuals may be synchronized remotely. For example, sales associates in the field may use a portable memory device 10 to store sales literature including images, product demonstration videos, manuals, and pricing. Upon inserting the portable memory device 10 into a primary host computer 12 or secondary host computer 11, the system 100 can be configured to automatically update itself and maintain the same set of files for all sales associates, ensuring that only the most recent product information and pricing is delivered to the associates. This is also potentially applicable to students who wish to stay up to date on their class syllabus, fans of any specific type of multimedia content (i.e. bands, television shows) who wish to stay up to date on new material, and many other types of applications.

Preferably, the portable graphical user interface is developed using Adobe® Flash® Software. Advantageously, Flash® can be executed and displayed on both PC and Mac platforms. While Flash® is primarily designed to be used to develop web-based applications, allowing developers to provide multimedia content to the users having the Flash® plug-in installed in their web-browsers, it is also possible to develop stand-alone applications and take advantage of the built-in features of Flash®. As is known in the prior art, Flash® natively supports the playback of audio files, including MP3 files, and additionally provides other advantageous features that make it an ideal choice for programming graphical user interfaces. However, the use of Flash® alone is insufficient to create the novel features of the present invention. Significant programming is required to allow Flash® to cooperate with the operating system in the manner as claimed in the present invention.

The file system accessible by the user via the portable graphical user interface is preferably programmed using C++ programming language. C++ is a common language used in the development of Windows-based and Mac-based applications. By programming in C++, versatility in features is obtained across both platforms. While the cross-platform compatibility of Flash® is advantageous in the creation of the software made according to the present invention, the coupling of a C++ application with Flash® presented challenges which were overcome via the use of Zinc™ software developed by Multimedia Limited (MDM), which contains a collection of tools for developers using Flash®. By using Zinc™ in combination with the underlying file system application developed in C++, a .SWF file, or native Flash® format file, can be converted into a self-executable file that does not require the platform to have Adobe® Flash® software already installed on the system. In this respect, these tools assist in the creation of the software but do not, by their very nature, contain the novel features of the present invention.

Preferably, the portable memory device is a flash memory drive, which is also known as a “thumb drive,” “memory key” or “flash drive.” However, the types of memory available for portable electronics changes are anticipated to develop rapidly and to the extent that such memory formats change, the present invention is intended to work with such developing formats. For example, the portable memory device 10 may be of any non-volatile memory device such as Compact Flash cards, SD cards, Transflash Cards, Mini-SD cards, and other types of media. It is also anticipated that the I/O interface for such portable memory devices will evolve from the current standard of USB (Universal Serial Bus) to others that may provide faster throughput. Preferably, the portable memory device 10 is a flash memory device that connects to the computer via a USB port. Advantageously, the USB port is found on both PCs and Apple® Mac computers, compared to Firewire ports, which can be faster than USB, but are not as common on traditional PCs and newer Apple® Mac computers.

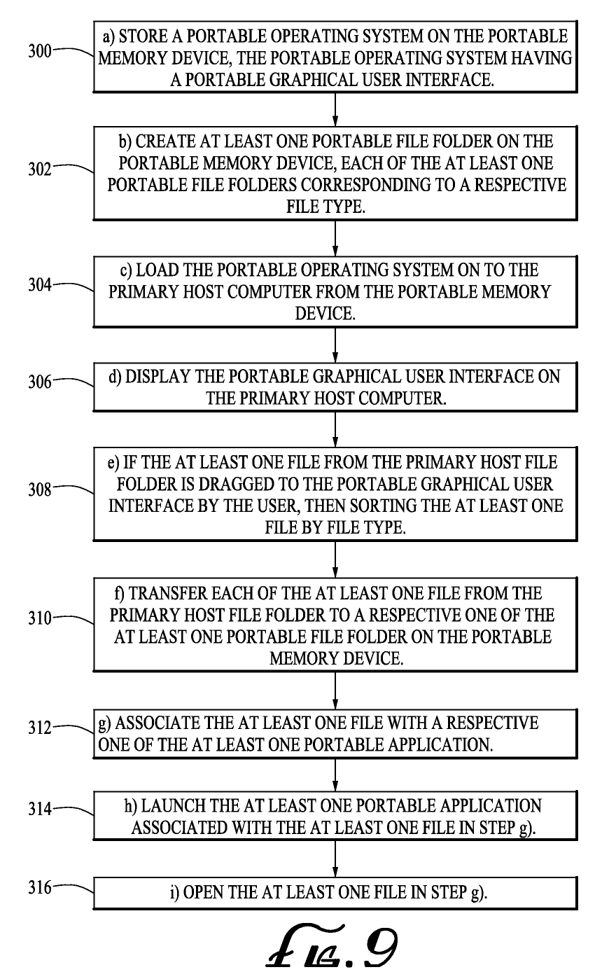

As shown in FIG. 9, there is also provided a method of allowing a user to transfer at least one file from a primary host file folder in a primary host computer to a portable memory device, and providing the user with access to the at least one file. The method includes storing a portable operating system on the portable memory device 300, the portable operating system having a portable graphical user interface. The logic proceeds to box 302 where at least one portable file folder is created on the portable memory device, each of the at least one portable file folders corresponding to a respective filetype. The logic proceeds to box 304 where the portable operating system is loaded on to the primary host computer from the portable memory device. The logic proceeds to box 306 where the portable graphical user interface is displayed on the primary host computer. The logic proceeds to box 308 where if the at least one file from the primary host file folder is dragged to the portable graphical user interface by the user, then the at least one file is sorted by filetype. The logic proceeds to box 310 where each of the at least one files is transferred from the primary host file folder to a respective one of the at least one portable file folders on the portable memory device.

Optionally, the logic proceeds to box 312 where at least one file may be associated with a respective one of the at least one portable application. This may be performed independently of default file associations defined by the primary host computer. The logic may proceed to box 314 where the at least one portable application may also be launched and associated with the at least one file and opened for access by the user as in box 316. Such association may be performed without user interaction when the portable memory device is connected to one of the primary and secondary host computers.

As a further advantage, it is contemplated that the system 100 may be used in conjunction with an advertisement delivery system and/or as a method of advertising. In this respect, a portable memory device may be branded on behalf of a company and then distributed to a group of individuals such that the portable graphical user interface is customized for the intended promotional purpose. For example, “skin” may be developed which overlays on to the existing portable graphical user interface such that a company's logo and images of their product appear thereon. The system 100 may then be used as a way of delivering information to potential customers and/or promoting a particular product. This may be particularly useful for a company wishing to track the effectiveness of their marketing campaign by tracking the use of the system 100 by the potential customers.

As a further advantage, the system 100 may be used by students to convert their Apple® iPod® MP3 players and other MP3 players into full functional portable storage devices. As is well known in the art, the iPod® and other MP3 players may be connected to computers and accessed just as if it was any other type of media. Thus, files that are not necessarily supported by the MP3 player may be stored on the device. Advantageously, by installing the system 100 in such a MP3 player, a student's documents, pictures and other multimedia files may be stored and viewed on any public computer. This is a problem in most school computer labs because the iPod® requires the use of iTunes® software to properly play any of the music on the iPod® unless some other third-party music playing software is used. Moreover, iTunes® software has extremely strict DRM (Digital Rights Management) software that does not allow an iPod® user to listen to any songs from the iPod® via iTunes® on a computer that is not authorized to play the music with DRM. While the current system certainly does not circumvent the DRM, it provides a solution to a problem where the legitimate licensee is unable to access their music. To further complicate this problem, most school computers do not have iTunes® on the computer lab computers and do not allow students to download new applications to the desktop. Thus, the student is often unable to listen to the music on their iPod® unless they directly plug into it with a pair of headphones. Yet, long hours in the computer lab will eventually drain the iPod® battery. So, to allow students to listen to music on their iPod®, a portable music player such as WinAmp® or the internal player in the system 100 can play the music on the iPod® so that the student can truly access all of their school work, listen to their music through the computer's speakers or headphone output, and keep their iPod® charged up at the same time by simply carrying their iPod® and a USB cable.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

1. A portable operating system for use by a user on a portable memory device, the system being accessible by the user on a primary host computer having a host graphical user interface, the system comprising:
a portable graphical user interface accessible by the user when the portable memory device is placed into communication with the primary host computer;
at least one portable application executable by the user via the portable graphical user interface;
a file system accessible by the user via the portable graphical user interface for bidirectional transfer of files between the portable memory device and the primary host computer, the file system defining at least one portable file folder on the portable memory device for storing at least one file therein, each of the at least one portable file folders corresponding to a respective filetype; and
wherein dragging at least one file from the host graphical user interface of the primary host computer to the portable graphical user interface triggers the file system to transfer each of the at least one file into a respective one of the at least one portable file folder corresponding to the respective filetype.

2. The system as in claim 1 wherein the at least one file is associated with a respective one of the at least one portable application such that execution of the at least one portable file launches the at least one portable application associated therewith.

3. The system as in claim 2 wherein execution of the at least one portable application is performed independently of default file associations defined by the primary host computer.

4. The system as in claim 1 wherein the portable graphical user interface is configured to be compatible with a second host computer having a different operating system than the primary host computer.

5. The system as in claim 4 wherein the portable graphical user interface is automatically launched without user interaction when the portable memory device is connected to one of the primary and secondary host computers.

6. The system as in claim 1 wherein the portable application is a music player.

7. The system as in claim 6 wherein the at least one portable file folder includes a music file folder.

8. The system as in claim 7 wherein the filetype corresponding to the music file folder is a music file.

9. The system as in claim 1 wherein the at least one portable file folder is selected from the group consisting of a music file folder, a photo file folder, a document file folder, and a video file folder.

10. The system as in claim 9 wherein the portable application is selected from the group consisting of a music player, a photo viewer, a document editor, and a video player.

11. The system as in claim 1 wherein the portable graphical user interface is configured to connect to a master server via the Internet and store identification corresponding to the portable memory device thereon.

12. The system as in claim 1 wherein the portable graphical user interface is programmed using Adobe® Flash® software.

13. The system as in claim 12 wherein the file system is programmed using C++ programming language.

14. The system as in claim 13 wherein the portable graphical user interface and the file system are compiled together using MDM Zinc™ software.

15. A system comprising:
a portable memory device;
a portable operating system installed on the portable memory device for use by a user, the system being accessible by the user on a primary host computer having a host graphical user interface, the system having:
a portable graphical user interface accessible by the user when the portable memory device is placed into communication with the primary host computer;
at least one portable application executable by the user via the portable graphical user interface;
a file system accessible by the user via the portable graphical user interface for bidirectional transfer of files between the portable memory device and the primary host computer, the file system defining at least one portable file folder on the portable memory device for storing at least one file therein, each of the at least one portable file folders corresponding to a respective filetype; and
wherein dragging at least one file from the respective Graphical user interface of the primary host computer to the portable graphical user interface activates the file system to transfer each of the at least one files into a respective one of the at least one portable file folders corresponding to the respective filetype.

16. The system as in claim 15 wherein the portable memory device is a flash memory drive.

17. The system as in claim 15 wherein the at least one file is associated with a respective one of the at least one portable application such that execution of the at least one portable file launches the at least one portable application associated therewith.

18. The system as in claim 17 wherein execution of the at least one portable application is performed independently of default file associations defined by the primary host computer.

19. The system as in claim 15 wherein the portable graphical user interface is configured to be compatible with a second host computer having a different operating system than the primary host computer.

20. The system as in claim 19 wherein the portable graphical user interface is automatically launched without user interaction when the portable memory device is connected to one of the primary and secondary host computers.

21. A method of allowing of user to transfer at least one file from a primary host file folder in a primary host computer to a portable memory device, and providing the user with access to the at least one file, the method comprising the steps of:
a) storing a portable operating system on the portable memory device, the portable operating system having a portable graphical user interface;
b) creating at least one portable file folder on the portable memory device, each of the at least one portable file folders corresponding to a respective filetype;
c) loading the portable operating system on to the primary host computer from the portable memory device;
d) displaying the portable graphical user interface on the primary host computer;
e) if the at least one file from the primary host file folder is dragged to the portable graphical user interface by the user, then sorting the at least one file by filetype; and
f) transferring each of the at least one file from the primary host file folder to a respective one of the at least one portable file folder on the portable memory device.

22. The method as in claim 21 wherein the portable operating system further includes at least one portable application executable by the user via the portable graphical user interface, and further comprising the step of:
g) associating the at least one file with a respective one of the at least one portable application.

23. The method as in claim 22 further comprising the steps of:
h) launching the at least one portable application associated with the at least one file in step g); and
i) opening the at least one file in step g).

24. The method as in claim 22 wherein step g) is performed independently of default file associations defined by the primary host computer.

25. The method as in claim 21 wherein the portable graphical user interface is configured to be compatible with a second host computer having a different operating system than the primary host computer.

26. The method as in claim 25 wherein step h) is performed without user interaction when the portable memory device is connected to one of the primary and secondary host computers.
